(19) United States
(12) Patent Application Publication
(10) Pub. No.: US 2002/0198768 A1
(43) Pub. Date: Dec. 26, 2002

(54) Method for organizing, motivating and entertaining using the internet

(76) Inventor: John Huppenthal, Chandler, AZ (US)

Correspondence Address: John Huppenthal, 8 Bullmoose Circle, Chandler, AZ, 85224, US

(21) Appl. No.: 09/822,674

(22) Filed: Mar. 30, 2001

(51) Int. Cl. G06F 17/60

(52) U.S. Cl. 705/14; 705/1

(57) ABSTRACT

A method for organizing, entertaining and motivating people using the internet with the steps of participation in a internet web-site, the step of joining groups, teams, divisions, clusters or pods on the web-site, the step of automatic membership in successively nested groups until all participants share one common group, the step of participants ranking other participants on the web-site, the step of participants ranking groups on the web-site, the step of giving internet corporate stock ownership rewards as a function of performance measures for the internet site, the step of giving internet web-site corporate stock rewards as a function by formula of the ranking of an individual participant, the step of giving internet web-site corporate stock rewards calculated by formula as a function of the ranking of a group, the step of membership within successively nested groups, the step of stock rewards calculated by formula as a function of the ranking of successively nested groups, the step of rankings as frequently as daily, and the step of rewards as frequently as daily.

### BACKGROUND-FIELD OF INVENTION

This invention relates to the design of an internet web-site, specifically to a method of organizing, entertaining and motivating web-site participants.

### References Cited

| | | | | |
|---|---|---|---|---|
| 5,926,794 | July 20, 1999 | Fethe | 705 | 11 |
| 5,551,880 | Sep 3, 1996 | Bonnstetter | 434 | 236 |
| 4,671,772 | June 9, 1987 | Slade | 434 | 219 |
| 4,627,818 | Dec. 9, 1986 | Von Fellenberg | 434 | 236 |
| 4,863,485 | Sep 5, 1989 | Slade | 434 | 107 |
| 5,117,353 | June 26, 1992 | Stipanovich | 705 | 11 |
| 5,301,320 | May 5, 1994 | McAtee | 395 | 650 |
| 5,306,154 | April 26, 1994 | Ujita | 434 | 218 |
| 5,365,425 | Nov. 15, 1994 | Torma | 705 | 2 |
| 5,500,795 | Mar. 19, 1996 | Powers | 705 | 11 |
| 5,826,020 | Oct. 20, 1998 | Randell | 395 | 200 |
| 5,826,239 | Oct. 20, 1998 | Du | 705 | 8 |
| 5,909,669 | June 1, 1999 | Havens | 705 | 11 |
| 5,995,940 | Nov. 30, 1998 | Ramaley | 705 | 9 |
| 6,108,493 | Aug. 22, 2000 | Miller | 395 | 200 |
| 5,954,510 | Sep 21, 1999 | Merrill | 434 | 236 |
| 5,983,214 | Dec. 9, 1999 | Lang | 707 | 1 |
| 6,023,729 | Feb. 8, 2000 | Samuel | 709 | 228 |
| 6,029,141 | Feb. 22, 2000 | Bezos | 705 | 27 |
| 5,870,744 | Feb. 9, 1999 | Sprague | 707 | 9 |
| 6,061,681 | May 9, 2000 | Collins | 707 | 5 |
| 6,073,138 | June 6, 2000 | De l'Etraz | 707 | 104 |
| 6,093,026 | July 25, 2000 | Walker | 434 | 322 |
| 6,174,237 | Jan. 16, 2001 | Stephenson | 463 | 42 |
| 6,189,029 | Feb. 13, 2001 | Fuerst | 709 | 217 |

### Other References Cited

The Art and Science of 360 Degree Feedback; Lapsinger, Richard;
San Fransisco, CA, Pfeiffer, 1997, pgs 66, 67, 204-209, 215-217, 221,
Exhibit A.3. 234, 235, 240, 241
Improving Performance With Feedback: 51 Practical Strategies for Using
360 Degre Feedback in Training; Carless, Sally A.; Melbourne, Australia:
Melbourne Business School; University of Melbourne, 1995, pgs 43, 45,
47, 112
Value of 360 Degree Employee Performance Appraisals in the United
States Army; Marvin, Michael A.; Carlisle Barracks, PA: US Army War
College, 1996, pgs. 13, 18-21, 23

### BACKGROUND-DESCRIPTION OF THE PRIOR ART

The history of organization technology is the history of human behavior. The development of agriculture represented a huge change in the size and dynamic of human organization. Agriculture enabled humans to create larger groups than hunting enabled. This change in scale began approximately 10,000 years ago. By comparison, the development of man's biological impulses is theorized to have evolved over hundreds of millions of years. The biological drive of small groups to mark turf, cooperate internally and compete externally has challenged the development of efficient organizations since the dawn of agriculture.

Social behavior is driven by the biological drive to survive, join and gain status. Society's organizations do a poor job of aligning that biological imperative with organization goals and objectives.

The act of joining is defined and enhanced by the creation of positive interdependence between two or more people. Positive interdependence is the existence of a win/win relationship arising out of mutual benefit from cooperating. Current organizations create relatively weak positive interdependence among some of their members, neutral interdependence between others and some weak to intense negative interdependencies.

The internet provides the potential for a huge leap forward in improving the efficiency of organizing and motivating human effort. This potential remains largely untapped.

Geography limits traditional company's ability to organize people. The largest number of people in one building in a Fortune 500 companies is less than 20,000 employees.

Current organization forms make it extraordinarily expensive to gather people and utilize their skills. The average compensation of a full-time worker is over $35,000 per year. The additional cost of office space and benefits drives this number to over $50,000 per year.

Current organizations encourage dependency on superiors within the organization. In even the very best companies, the voice of “management” speaks much louder than the voice of other workers in the organization. They lack democratic principles necessary for high job satisfaction.

Current organizations deprive typical workers of any say in the selection of organization leadership.

Current organizations provide feedback to participants typically once per year as to their current status.

Current organizations have made very limited attempts to democratize their organizations through the use of 360 degree feedback. This method typically allows an employee to select from three to perhaps as many as 15 fellow employees to rate their performance. The art of 360 degree review is overly complex with as many as forty dimensions of performance common.

The 360 degree review is approached primarily as a measurement of people, not as a linkage creating positive interdependence.

The 360 degree review process provides limited opportunities for participants to gain status because it allows all of its participants to be ranked equally.

The 360 degree review process is bureaucratic, often taking as long as four months to complete within a company.

The current 360 degree review process is only one fragment of a larger process of motivating participants in an organization. As just one part of a system, the rest of the components may or may not achieve the motivational energy needed to maximize the performance of the organization.

The 360 degree review process is limited to participants. As such, it fails to link more than the direct number of people being ranked by a participant. It does not apply to teams, departments, divisions or subsidiaries. Thus, it does not contribute to the positive interdependence being developed by larger reward systems linked to stock prices, return on equity, profitability, cash flow customer satisfaction and other measures of product quality.

The 360 degree review process is weakly linked to pay, the literature search reveals no guidance on how to link the 360 degree review with pay.

The rewards for individual performance are not directly linked to the performance of the total organization.

Individual performance is calculated most frequently quarterly and typically annually.

Organizations depend on the human drive to maintain and gain status to motivate members. Typically, status levels within traditional organizations are rigid. Some well known examples: Pope, bishop, monsignor, priest, King, duke, serf, emperors, Chief executive officer, Chief operating officer, president, vice-president, manager. Changing the status of a member or leader is difficult. For example: murder, death of incumbent, expensive promotion, painful demotion, firing. Because of the rigidity and difficulty, changes in status are infrequent. For example some positions are granted for life and holding one level of status for an entire career is common.

### BACKGROUND: TECHNOLOGY TIMELINE OF PRIOR ART

2.5 million B.C. to 10,000 B.C. humans organized in groups of 20 to 150 for hunting and gathering

10,000 B.C. to 1800 A.D. humans organized around agriculture in groups of 100 to 8 million for efficient farming, hunting and socialization.

1200-1800 A.D. humans begin organizing as companies to develop products and services

1860-1890 Proctor and Gamble begins profit sharing program

1940-1960 United States Armed Forces use peer ranking as an individual performance measure

1955-1960 Hewlett Packard begins profit sharing

1965 to 1970: Measured customer satisfaction introduced as an instrument of organization success

1960 to 1990: General Electric adopts peer review as a measure of individual performance

1955 to 1999: the Gore company adopts blended peer and administrative ranking at the individual level

1980-1985 Charles Schwab integrates customer satisfaction into their compensation package

1980-1985 Xerox integrates customer satisfaction into their compensation package

1990 - 1995 IBM integrates customer satisfaction into their compensation package

1990-1995 Intel integrates customer satisfaction measures into their compensation package

1970 to 1995 The Intel corporation integrates peer rating and supervisory ranking in their compensation system.

1990-1995 Intel provides all employees with stock options linked by formula to individual status as established by ranking and rating.

1995-1998 Internet service providers begin experimenting with providing stock to customers

### SUMMARY

In accordance with the present invention a web-site comprises a method for joining, a grouping system which links all participants, a ranking system which creates a status measurement for all participants and a reward system which ensures participation and creates intense positive interdependence.

### Objects and Advantages

Accordingly, besides the objects and advantages of the web-site method described in my above patent, several objects and advantages of the present invention are:

a) to provide a direct benefit to the participant for the web-site success, thus motivating the participant to act to further the success of the web-site

b) to provide a system of teams for the participant to join ensuring a direct connection between the participant and all other participants

c) to provide a system of ranking participants and teams to further connect all participants in the web-site activities

d) to provide an exact measure of the participants status in the web-site thus motivating the participant to pursue improvement in status

e) to provide rewards to the participant which enhance their sense of joining and increasing status

f) to provide rewards to the participant thus motivating them to join and perform the rankings

g) to organize an infinite number of participants through a system of successively nested groups

### DRAWING FIGURES

FIG. 1. Depicts a level one group (team).

FIG. 2. Depicts a level two group and the containment of level one groups by level two groups.

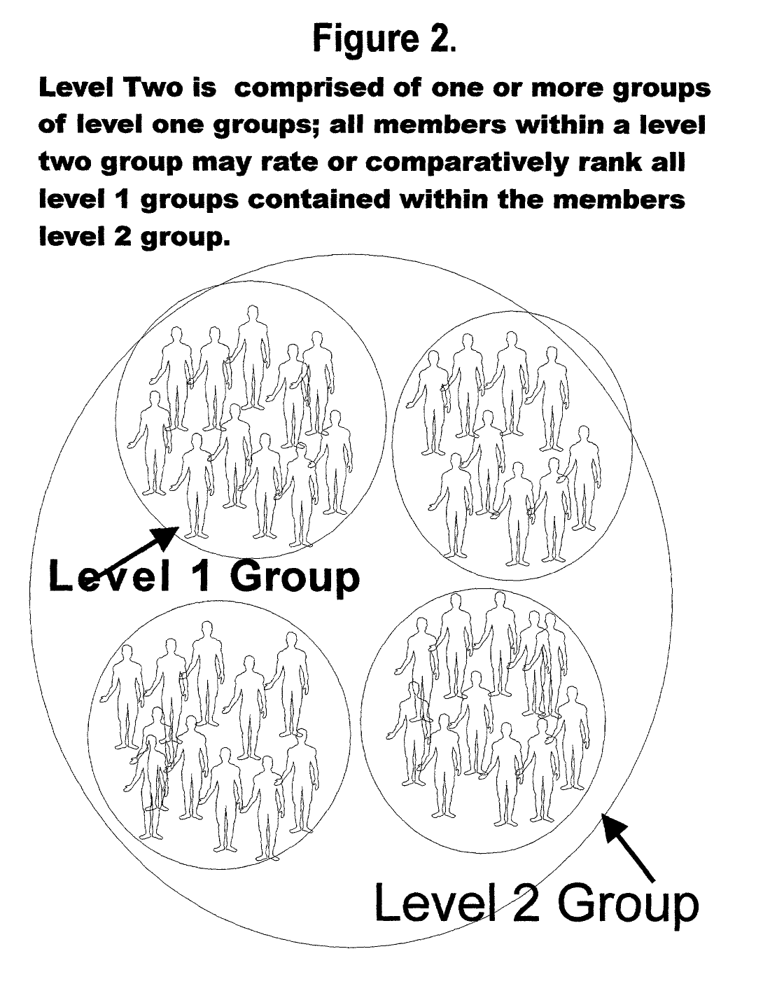

FIG. 3. Depicts a level three group and the containment of levels one and two groups by level three groups.

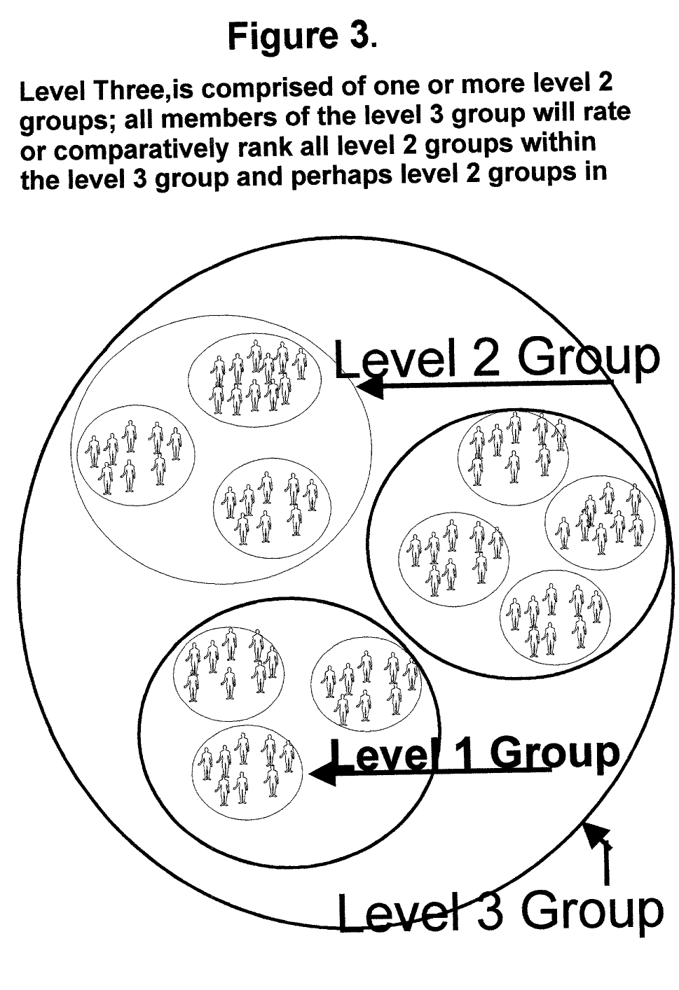

FIG. 4. Depicts a level four group and the containment of levels one, two, and three groups by level four groups.

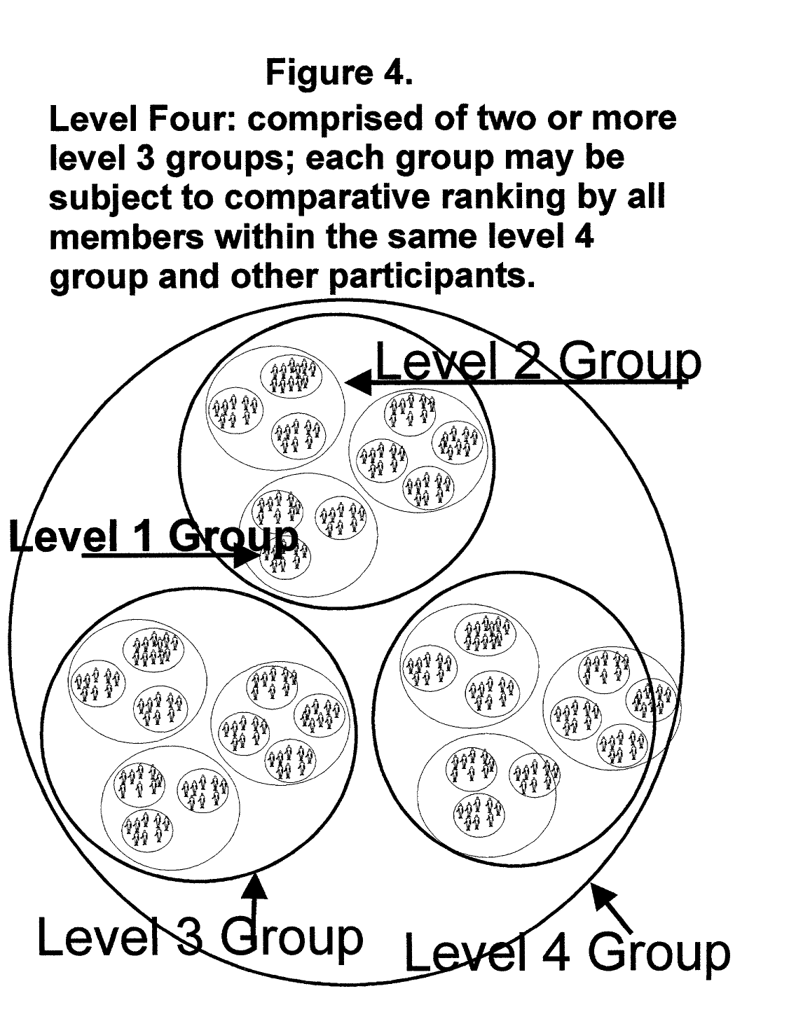

FIG. 5. Depicts a level five group and the containment of levels one, two, three and four groups by level five groups.

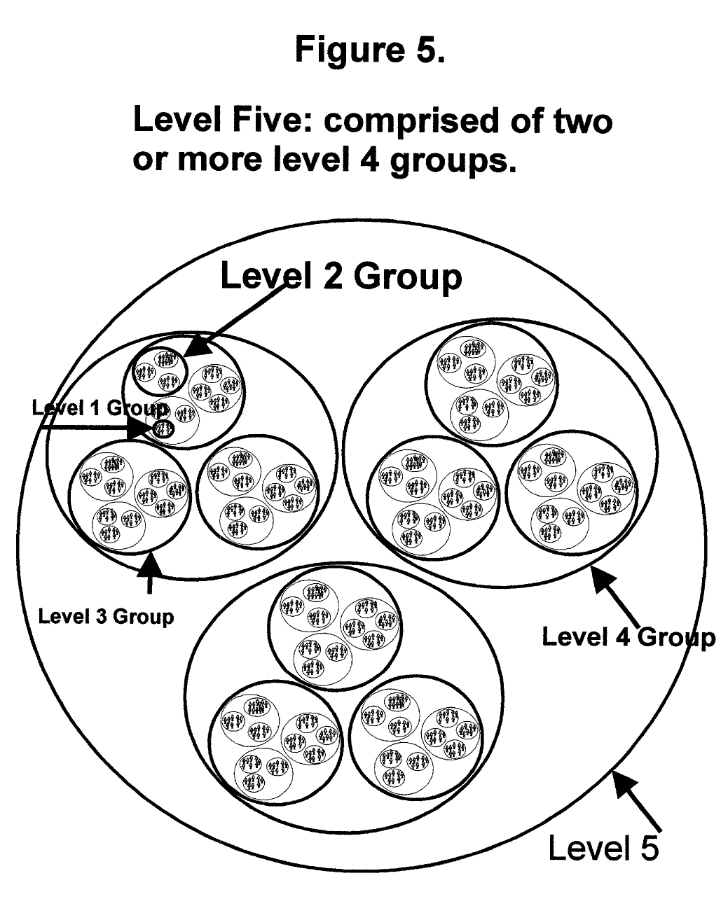

FIG. 6. Depicts an extension of the ranking process to bubbling, the development of new teams by promotion of members of level one teams.

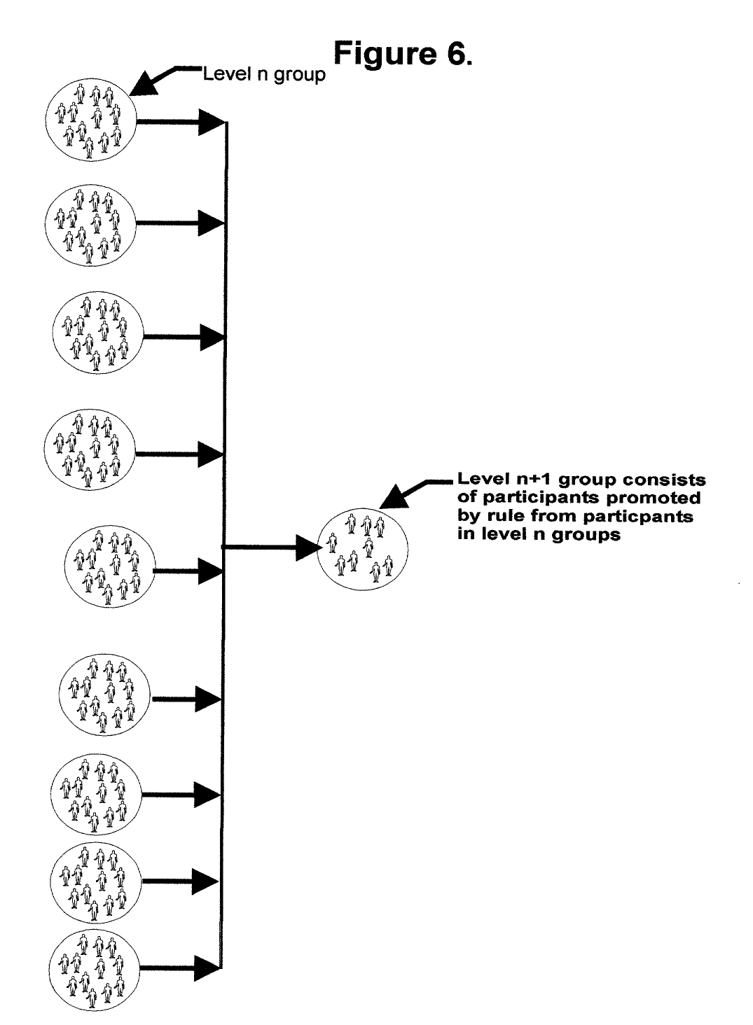

FIG. 7. Depicts an extension of the ranking process to bubbling, the development of new teams by promotion of multiple members of level one teams.

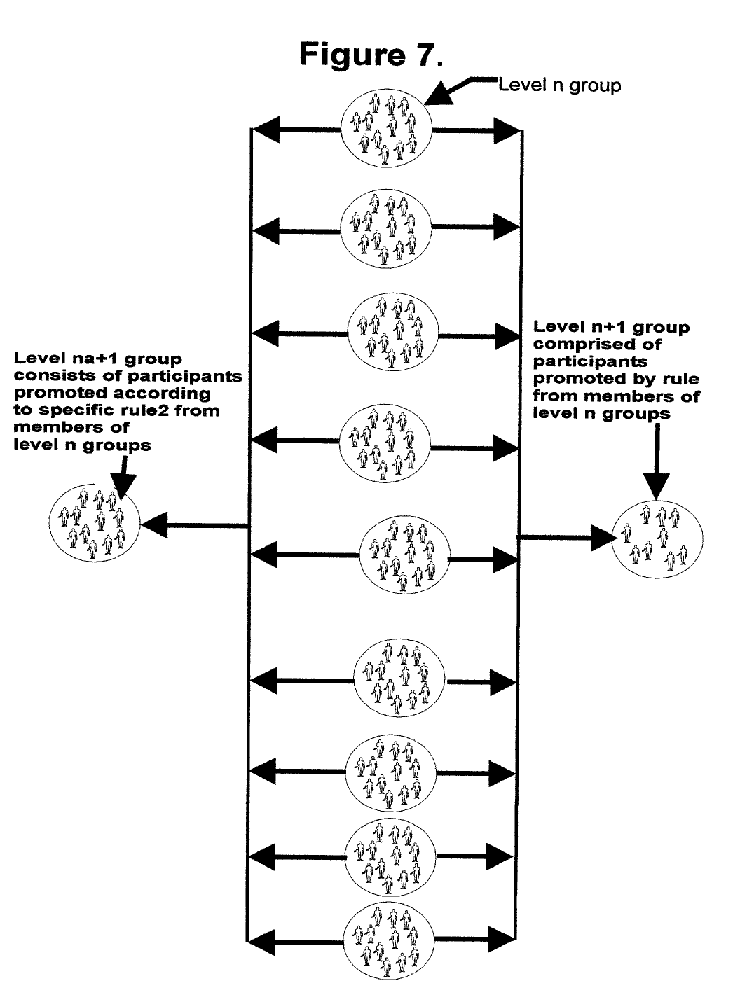

FIG. 8. Depicts a web-site interface or computer screen typifying the potential ranking process of participants

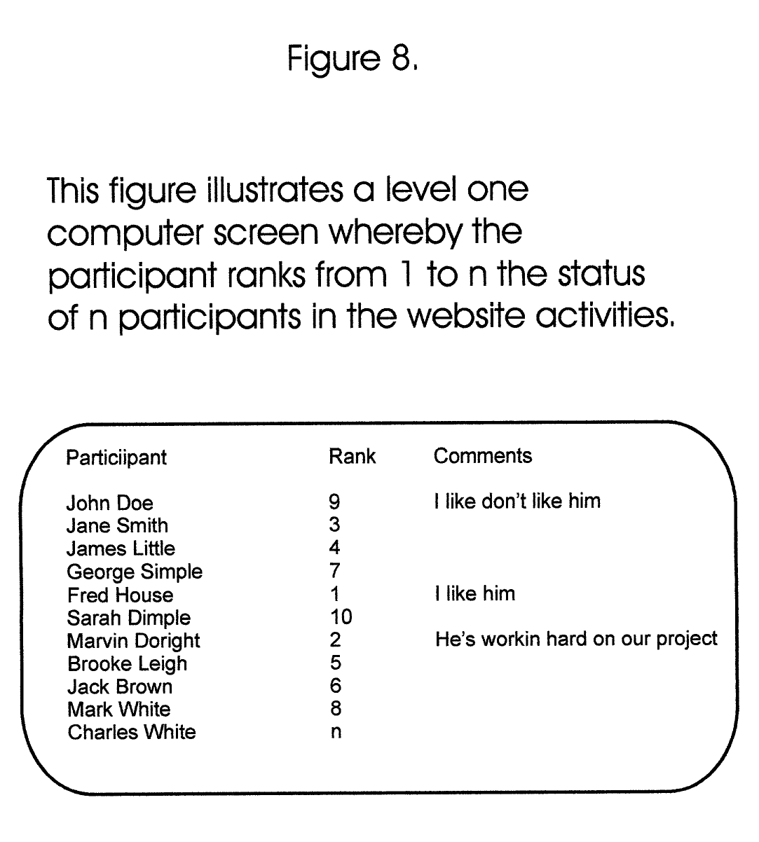

FIG. 9. Depicts a web-site interface or computer screen typifying the potential ranking process of internet web-site groups from level 1 through level n.

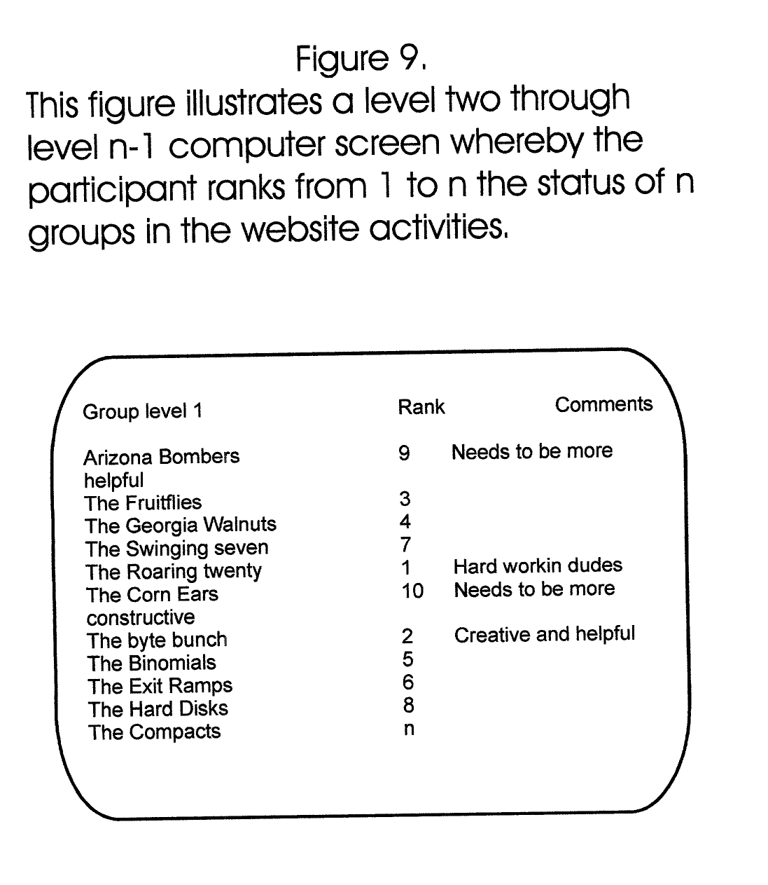

### THEORY OF OPERATION

The underlying theory of operation of the process is built on several fundamental principles. The first are the keys to human motivation: to 1.) survive, 2.) join, and 3) gain status. In this system, all participants join teams and frequently given a status ranking for themselves, their level 1 group, their level 2 group up to the level n-1 group of which they are a member.

The process also makes a direct appeal to the desire for money. Members can gain potentially highly valuable stock in return for a modest investment of initial time (joining and performing the rankings).

The act of joining is characterized by a positively interdependent relationship with other members. The invention structure creates explicit positive interdependence in all dimensions of potential relationships. Thus, the act of joining the web site groups will have emotional, entertaining benefits as well as financial benefits.

Over time, it is expected that participants in each team will develop friendships with other team members as they seek to improve the status of their team. It is also expected that members will invite acquaintances to become participants because the act of expanding the site will be a performance that other participants will acknowledge through higher rankings and because higher membership will increase the value of the web-site and stock bonuses to members.

It is subject to change on a real time basis. This change in status would be in response to the organization's perception of the value creation by the individual and the value creation by the groups of which he is a member.

### Preferred Embodiment

The preferred embodiment of the method consists of a web site that invites visitors to join and become members. Such members would be attracted by the benefit of receiving of stock in the web-site corporation in return for participating in the web-site method of organizing, motivating and entertaining members.

The members would join both the web-site and a specific team (also defined as a level one group). They would be free to join any team in existence on the web site and might be joining as a result of an invitation to participate by a member of the team they are joining. When a participant joins a level 1 group (team) they automatically become a member of a level 2 through level n group where level n is defined as the number of levels which contain all participants.

### Joining the web-site

Joining the web-site is a multiple facet process. First, an interested participant would register with the web-site as a participant. Second, they would select a team or group to join. Finally, their membership in that level 1 team or group would automatically make them a member of higher level groups of which that level one team is a member. An analogy is that someone who joins a homeowners association is automatically a resident of a city, a state, the United States.

### Performing rankings to determine status within the web-site community

Each participant is given a voice in the process of organizing the web-site community. This voice is expressed in the form of a sequential, consecutive, unique, hierarchical ranking of other participants and other groups participating in the web-site. It is envisioned that the participant would rank the members of her level one team from first to last. So, one participant would be ranked first, another second, still another would be ranked third and so forth until all members within the level one team have been ranked.

This ranking process would then be applied to groups. So, the participant would rank all groups or teams that are members of the same level-two group as the participant. This is analogous to a resident of Phoenix ranking all homeowners associations in Phoenix. The participant would be assisted in the ranking process. This assistance would comprise a listing of the previous ranking results for these groups as an aid to the current ranking process.

The ranking of groups would continue in succession for each level of groups. This is analogous to a resident of Phoenix first ranking the members of their homeowners association, next ranking all homeowners associations in Phoenix, next ranking all cities in Arizona, next ranking the states in the nation and finally ranking the countries of the world. Thus, every participant in the process would have linkage to every other participant in the process.

### Rewards

Each participant is entitled to a system of rewards. First, they would receive periodic corporate web-site stock just for being a member. Second, they would receive corporate web-site stock for submitting rankings. Third, they would receive corporate web-site stock as a calculated function by formula of their personal ranking. Fourth, each participant would receive corporate web-site stock as a calculated function by formula of the ranking of each group of which they are a member.

### Growth in web-site membership

The web-site is expected to grow exponentially as participants are attracted by the offer of stock. As the web-site grows, it would require more levels of groups to contain all members. For example at an average group size of 10 members and an average of 10 groups nested within each successively nested group, it would require one level to contain one hundred members and nine levels to organize the entire population of the world.

### Rationalizing Rankings

In addition to the ranking, it is anticipated that the web-site program would allow the member conducting the ranking to provide comments rationalizing the ranking. These comments would be available to the member being ranked and to the successively nested groups being ranked. So, a member would be able to access comments on his ranking, his level one group (team) ranking, their level two ranking, and any successive rankings that exist.

This feedback is critical to the processes of developing the web-site culture as composed of subcultures at the level one (team), level two, and successive level cultures.

### Creation of web-site groups (teams)

Any member would be free to start a new team (level one group), or level two group, or successively higher group. There would be rules for the minimum number of members and groups required to open a new team (level one group) or the minimum number of groups required to start a higher level group to ensure an orderly process of opening up new comparative rankings.

### Frequency of feedback through comparative ranking

A key feature of the site is frequency of feedback. Such rankings might be submitted as frequently as daily. However, it is anticipated that weekly might be the optimal frequency. It is anticipated that members might be able to access their comparative rankings on a real time basis. Thus, as members submit their rankings within the rating period, the social rank of any member might change. It is anticipated that any possible change in status would be of high interest to the members and stimulate their frequent access to the site.

### Communication

Another key feature of the site is the chat board. It is anticipated that each team will have a bulletin board to share ideas and conduct electronic conversations. Such bulletin boards or chat rooms will exist for each successively nested group. Thus, a member would have a chat room for his level one team, level two group, level three group, etc.

### Extension of the core concept: Alternative embodiment or extension

An extension of the core concept consists of establishing new teams comprised of the highest or highly ranked members of each level one group. In this extension, additional levels are formed in a different dimension on the web-site. These additional levels are formed not from successive groupings of level one groups, level two and successively nested groups but from members who “bubble out” or are promoted out of level one teams. For example, the top ranked member of each team becomes a member of a new team consisting of the top ranked members of all other teams in his level two group. At the same time, they retain their membership in their core level one group (team). Thus, if there are ten level one groups within a level two group, a “leadership” group of ten members is formed from the top ranked member of each level one group. This bubbling might continue for each successive level. For example, if the web-site consisted of 9 levels, 9 successive leadership teams would form each from the top ranked members at the prior level. This would continue until one individual is promoted to the top by being the top ranked member of the highest level leadership group.

This concept might be further enhanced by allowing second ranked and even third ranked members to bubble out to a higher level group in a double or triple elimination process.

These bubbling rankings might occur on a different perhaps less frequent timing than the core concept rankings. This frequency would be carefully calibrated to provide membership duration stable enough to develop a site culture.

### Advantages

From the description above, a number of advantages of my web-site process become evident:

(a) An infinite number of participants can be organized through group structure design

(b) An individual participant can rise to a position of leadership in a short period of time

(c) Participants, who would otherwise be strangers, can be brought together to create an intense sense of community

(d) Participants can be motivated to work towards the success of the internet web-site

(e) Participants can be motivated to work towards group goals and objectives

(f) Participants can be motivated to attract other participants and increase participation in the web-site activities

(g) Participants can receive an exact measure of their status in the web-site community

### Operation

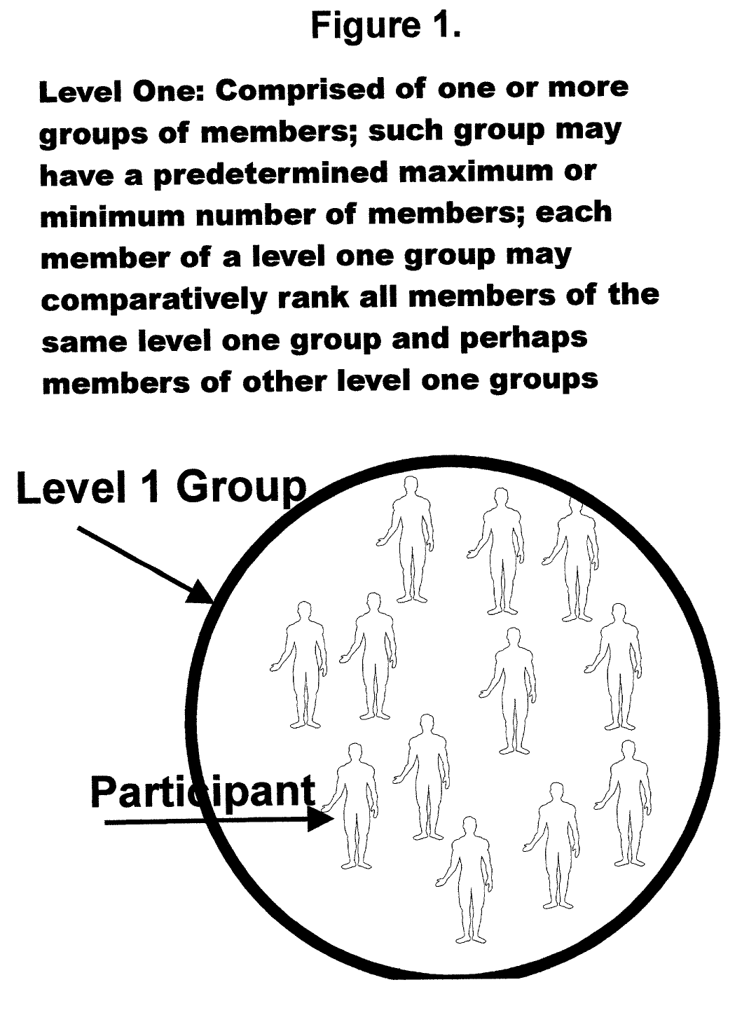

The manner of operating the web-site is as follows. First, a person registers as a participant with the web-site by providing identifying information. Next, the participant joins a level 1 group as shown in FIG. 1. If the participant does not have a preference for a particular group, the participant is assigned to a level 1 group. Assignment to a level 1 group automatically confers membership in level 2, level 3 and higher level groups. The number of levels would depend on the total number of participants. The participant would be immediately eligible to receive rewards for membership, rank within the group, and group rank within each level.

To receive these rewards, the participant would be required to submit rankings of other participants and other groups. This ranking process would be presented to each participant by the web-site process.

### Conclusions, Ramifications, and Scope

Accordingly, the reader sees that the web-site process can be used to organize, entertain and motivate an unlimited number of participants. Thus, creating a solution to the challenge of creating a community on the internet. Participants can be organized at essentially no cost to the web-site operator eliminating the large costs associated with hiring and housing employees. Furthermore, the web-site process has the additional advantages in that

it permits the creation of a marketplace for talent, allowing participants to rise and fall quickly in response to their change in perceived performance

it allows participants to quickly and flexibly change work groups thus redeploying to positions of greater satisfaction and productivity

it allows leadership to quickly be identified and to rise to a position of optimum influence

the potential ramifications of the process are unlimited. A company, school, or political party could be organized and operated within the group and sub-group structure. It is anticipated that this system would provide a superior form of organization for any objective envisioned.

I claim:

1. A process comprised of an internet web-site with incentives to participate in the internet web-site activities, the improvement wherein such incentives are linked by formula to web-site performance, the benefit wherein the participants are motivated to improve web-site performance

2. The closure of claim 1 wherein said incentives are given in the form of stock ownership, the benefit wherein the incentives can be provided without cash expenditure

3. The closure of claim 1 wherein said incentives are linked by formula to web-site financial performance, the benefit wherein the participants have a direct measure of web-site performance

4. The closure of claim 1 wherein said incentives are linked by formula to web-site participation, the benefit wherein the participants are more directly motivated to solicit more participants

5. The closure of claim 1 wherein said web-site participants join groups of other participants; the benefit wherein the web-site appeals directly to the human desire to join groups

6. The closure of claim 5 wherein said participants join groups successively nested until all participants share common membership in at least one group; the benefit wherein all participants can be efficiently linked and made positively interdependent

7. The closure of claim 5 wherein said web-site has predetermined rules for group formation, the benefit wherein website business is conducted in an orderly fashion

8. The closure of claim 2 wherein said participants periodically rank the status of other web-site participants, the benefit wherein the web-site appeals directly to the human desire to gain status and wherein the participants are placed in a state of positive interdependence

9. The closure of claim 8 wherein the ranking is done hierarchically,

10. The closure of claim 9 wherein the hierarchical ranking provides each ranked participant with a unique rank; the benefit wherein that no two participants can be given the same rank

11. The closure of claim 8 wherein said participants perform rankings at least every month, the benefit wherein the participants are motivated to visit the web-site at least monthly

12. The closure of claim 8 wherein said participants perform rankings at least every two weeks, the benefit wherein the participants are motivated to visit the web-site at least every two weeks

13. The closure of claim 8 wherein said participants perform rankings at least every week, the benefit wherein the participants are motivated to visit the web-site at least every week

14. The closure of claim 8 wherein said participants perform rankings daily, the benefit wherein the participants are motivated to visit the web-site daily

15. The closure of claim 8 whereby participants receive rewards in return for submitting comparative rankings, the benefit wherein the participants are motivated to submit said comparative rankings

16. The closure of claim 15 whereby participants receive corporate stock ownership in the internet web-site corporation in return for submitting rankings, the benefit wherein cash is not required, participant's ownership of the web-site and participant is further motivated to help the web-site succeed

17. The closure of claim 8 wherein the web-site calculates an average rank for each participant by averaging the current rankings of all participants of said participant each time a new ranking is submitted by any participant of the said participant,

18. The closure of claim 17 wherein the web-site calculates a unique, hierarchical status rank for each participant by using a rule to settle ties; the benefit whereby no two members may be given an equal hierarchical rank thus maximizing motivation to gain status

19. The closure of claim 17 wherein the web-site provides each participant with access to a report of the ranked status of said participant each time a new ranking is submitted by any participant ranking said participant; the benefit wherein stimulates participants to visit the web-site frequently to view potential changes in said participant's status

20. The closure of claim 17 wherein the web-site provides each participant with a report of the ranked status of said participant at the end of each ranking period

21. The closure of claim 8 wherein the web-site provides a means for participants to enter comments along with each ranking, the benefit wherein said comments provide understanding as to the basis for the rank given, motivate the participant being ranked to visit the web-site to read such comments further developing the web-site sense of community

22. The closure of claim 21 wherein the web-site process provides each participant with a report of the comments associated with each entered ranking of the participant

23. The closure of claim 17 wherein rewards are provided to each participant as a function by formula of the ranked status of said participant; the benefit wherein that participants are motivated to undertake activities, behaviors and value creation to improve said status

24. The closure of claim 23 wherein said rewards are a function of ranked status of said participant and web-site performance the benefit wherein the participant is incented to pursue status improvement activities which align with and improve web-site performance

25. The closure of claim 24 wherein such incentives are linked by formula to the calculated value of the web-site corporation, the benefit wherein the incentives are more precisely defined for purposes of motivating web-site participants

26. The closure of claim 23 wherein said rewards are comprised of stock ownership in said internet web-site corporation, the benefit wherein the rewards do not require cash outlay

27. The closure of claim 23 wherein said rewards are a function of the ranked status of said participant and of the performance of the group of which said participant is a member, the benefit wherein the reward reinforces team identity and motivation to improve team performance and ranking

28. The closure of claim 2 wherein said participants periodically rank the status of other groups composed of participants in the web-site

29. The closure of claim 28 wherein the ranking is done hierarchically,

30. The closure of claim 29 wherein said ranking provides each ranked group with a unique hierarchical rank, the benefit wherein that no two groups can be ranked at the same level thus maximizing the motivated behavior to gain status

31. The closure of claim 28 wherein said participants perform rankings at least once every month, the benefit wherein participants are motivated to visit the web-site monthly to review group rankings, group identity is reinforced and motivation to improve group ranking is enhanced

32. The closure of claim 28 wherein said participants perform rankings at least once every two weeks

33. The closure of claim 28 wherein said participants perform rankings at least once every week

34. The closure of claim 28 wherein said participants perform rankings daily

35. The closure of claim 28 wherein said participants may perform rankings as frequently as they desire

36. The closure of claim 28 wherein the web-site provides a means for participants to enter comments along with each ranking wherein said comments may provide understanding as to the basis for the rank given; wherein the benefit provides for information developing the web-site community culture

37. The closure of claim 28 whereby participants are motivated to submit rankings by receiving rewards in return for submitting rankings

38. The closure of claim 37 whereby participants are motivate to submit rankings by receiving stock ownership in the internet web-site corporation in return for submitting rankings.

39. The closure of claim 36 wherein the web-site process provides each participant with a report of the comments associated with each entered ranking of every group of which the participant is a member

40. The closure of claim 39 wherein the web-site process provides each participant with access to a report of the comments associated with each entered ranking of every group of which the participant is a member each time a new ranking of said group is submitted by any participant in the web-site process

41. The closure of claim 8 wherein the web-site calculates an average rank for each group by averaging the current rankings of all participants of said group each time a new ranking is submitted by any participant of the said group,

42. The closure of claim 41 wherein the web-site calculates a unique, hierarchical status rank for each group by using a rule to settle ties; the benefit whereby no two group

43. The closure of claim 41 wherein the web-site provides each participant with a report with the ranked status of all web-site groups of which said participant is a member

44. The closure of claim 43 wherein rewards are provided to each participant by formula as a function of the ranked status of the groups of which said participant is a member

45. The closure of claim 44 wherein said rewards provided to each participant are a function of the ranked status of said participant and the ranked status of the groups of which said participant is a member.

46. The closure of claim 44 wherein said rewards are comprised of stock ownership in said internet web site corporation

47. The closure of claim 44 wherein said rewards provided to each participant are a function of the ranked status of said participant and the ranked status of the groups of which said participant is a member and the web-site performance

48. The closure of claim 44 wherein the rewards are a function of the performance of the web-site group of which said participant is a member

49. The closure of claim 48 wherein said performance is a function of group membership

50. The closure of claim 44 wherein said performance is a function of the financial performance of said group of which said participant is a member

51. The closure of claim 44 wherein such incentives are linked by formula to calculated value of the web-site corporation set up for purposes of providing incentives to web-site participants

52. The closure of claim 8 wherein participants are promoted from groups based on a predetermined rule, wherein participants are pooled into new groups after being successively promoted from prior groups with said promotion by predetermined rule,

53. The closure of claim 52 wherein said promotions continue successively according to predetermined rules

54. The closure of claim 53 whereby participants are motivated to participate by receiving stock in return for submitting comparative rankings of groups of fellow participants.
